(19) United States
(12) Patent Application Publication
(10) Pub. No.: US 2014/0117851 A1
(43) Pub. Date: May 1, 2014

(54) ILLUMINATION SYSTEM

(71) Applicant: Lextar Electronics Corporation, Hsinchu (TW)

(72) Inventors: Chun-Kuang CHEN, Taipei City (TW); En-Min WU, Taipei City (TW); Hui-Ying CHEN, Changhua County (TW)

(73) Assignee: Lextar Electronics Corporation, Hsinchu (TW)

(21) Appl. No.: 14/038,739

(22) Filed: Sep. 26, 2013

Related U.S. Application Data
(60) Provisional application No. 61/718,716, filed on Oct. 26, 2012.

(51) Int. Cl. H05B 37/00

(52) U.S. Cl. CPC H05B 37/00
USPC 315/86

(57) ABSTRACT

An illumination system includes a lighting unit, a rectifier circuit, a drive circuit and a time control circuit. The rectifier circuit rectifies an AC power from an external power source to a DC power. The drive circuit is configured for receiving the DC power and generating a first driving current. The control circuit includes a resistive element and an energy storage element. The energy storage element is electrically coupled to the resistive element, and the energy storage element is configured for charging while the external power source is supplying the power to the illumination system and generating a second driving current to the lighting unit. When the external power source turns off, the energy storage element generates a discharging current to the lighting unit with the resistive element to extend the time duration which a bright state of the lighting unit goes to a dark state.

### RELATED APPLICATIONS

This application claims priority to U.S. provisional application Ser. No. 61/718,716, filed Oct. 26, 2012, which is herein incorporated by reference.

### BACKGROUND

1. Field of Invention

The present invention relates to an illumination system. More particularly, the present invention relates to an illumination system with fading out lamp.

2. Description of Related Art

With the rapid development of the economy and technology, the requirements associated with the illumination lamps have been changed. Typically, the modern illumination system requires high efficiency, low power consumption, long lifetime, and low environmental pollution. Moreover, due to the great use of artificial lighting, the issues of such lighting on human physiological health and the ecological environment have been emphasized in recent years. To provide a better illumination environment, the dimming function of gradually increasing or decreasing brightness is included in the emitting light diode (LED) lamp. When the power of the lamp is suddenly turned off or turned on, the irritation caused by an abrupt change in brightness to the human eyes can be reduced. Also, the lamp can continue to emit light for a period of time as the lamp is suddenly turned off, so as to prevent danger or an accident from happening when a user is suddenly in a dark environment.

In general, the way to implement the dimming function in the LED lamp is by adding a capacitor connected in parallel to the output terminal of the driving circuit of the LED lamp. During normal operation, the power provided from the mains supply not only provides the power for illumination of the LED lamp, but also charges the capacitor. When the mains supply turns off, the capacitor supplies the power to the LED lamp, so that the LED lamp can be bright for a buffer time until the power stored in the capacitor is drained.

In this regard, when the capacitance of the capacitor is higher, more energy is stored and thus the buffer time for keeping lighting becomes longer. However, when the capacitance of the capacitor is high, the size of the capacitor is large. It is difficult to dispose such a capacitor having high capacitance in the present lamps with the requirement for the compact size.

Therefore, there is a need to extend the time duration which a bright state of a lamp goes to a dark state in an illumination system while realizing a compact size for the same.

### SUMMARY

An illumination system is provided. By adding an extra resistive element, the buffer time can be extended effectively.

The illumination system comprises at least one lighting unit, a rectifier circuit, a drive circuit and a time control circuit. The rectifier circuit is configured for receiving an AC power provided from an external power source and rectifying the AC power to a DC power. The drive circuit is electrically coupled to the rectifier circuit to receive the DC power and generates a first driving current. The time control circuit is electrically coupled to the drive circuit and comprises a first resistive element and a first energy storage element electrically coupled to the first resistive element in series. The first energy storage element is configured for charging while the external power source is supplying power to the illumination system and generating a second driving current to the lighting unit. When the external power source stops supplying power, the first energy storage element is configured for generating a discharging current through the first resistive element to the lighting unit to extend the time duration which a bright state of the lighting unit goes to a dark state.

According to one embodiment of the present invention, the time control circuit comprises a current limiting element. The current limiting element is configured for blocking the first energy storage element to discharge to the drive circuit.

According to one embodiment of the present invention, the current limiting element comprises a diode. The diode is electrically coupled between the drive circuit and the first energy storage element.

According to one embodiment of the present invention, the first energy storage element comprises a capacitor.

According to one embodiment of the present invention, the capacitor is an electrolytic capacitor.

According to one embodiment of the present invention, the illumination system further comprises a second energy storage element. The second energy storage element is electrically coupled between the drive circuit and the time control circuit in parallel.

According to one embodiment of the present invention, the second energy storage element comprises a capacitor.

According to one embodiment of the present invention, the lighting unit comprises at least one light emitting diode.

In the foregoing description, the present invention has the following advantages: (a) By using the energy storage element and resistive element, the time duration which a bright state of the lamp goes to a dark state is controlled; and (b) By using the feature of the current limiting element, the lighting unit can efficiently use the power stored in the energy storage element.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic circuit diagram of an illumination system according to one embodiment of the present invention;

FIG. 2A shows a waveform of discharging current of the energy storage element in FIG. 1 before the current limiting element is utilized; and

FIG. 2B shows the waveform of discharging current of the energy storage element in FIG. 1 after the current limiting element is utilized.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

It will be understood that, although the terms such as first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element,, component, region, layer or section discussed below could be termed a second element, component, region, layer or section without departing from the teachings of the present invention.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

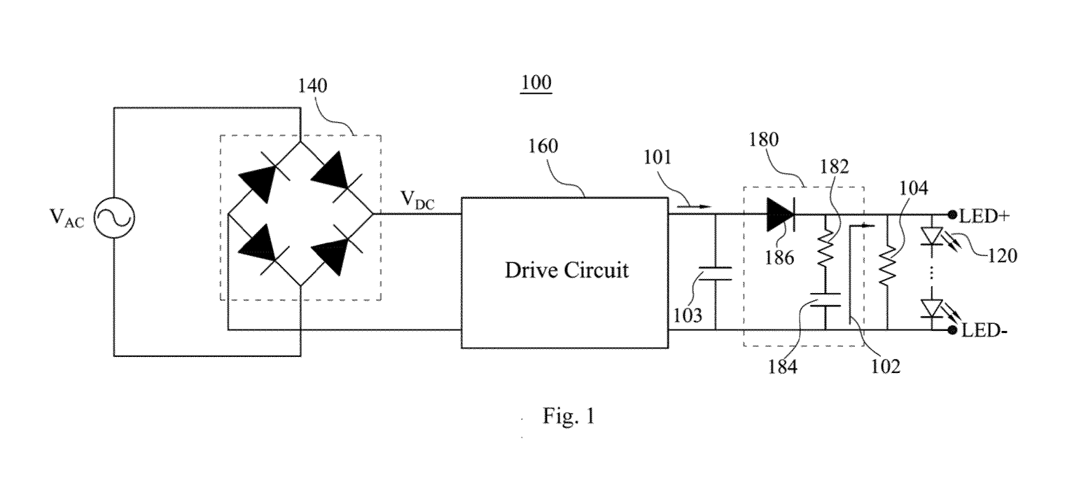

FIG. 1 is a schematic circuit diagram of an illumination system according to one embodiment of the present invention. As shown in FIG. 1, the illumination system 100 includes at least one lighting unit 120 (e.g. light emitting diode, LED), a rectifier circuit 140, a drive circuit 160 and a time control circuit 180. The rectifier circuit 140 is configured for receiving AC power V_{AC} provided from an external power source and rectifying the AC power V_{AC} to a DC power V_{DC}. For example, the rectifier circuit 140 may be a full-wave bridge rectifier circuit, a center tap type rectifier circuit, etc., and the person of ordinary skill in the art can choose one of any other type in accordance with the requirement of the practical applications. The drive circuit 160 is electrically coupled to the rectifier circuit 140 to receive the DC power V_{DC}, and generates a driving current 101 to provide power to the lighting unit 120 for emitting light. The time control circuit 180 is electrically coupled to the drive circuit 160, and includes a resistive element 182 and an energy storage element 184. The energy storage element 184 is electrically coupled to the resistive element 182 in series. The energy storage element 184 is configured for charging while the external power source is supplying the AC power V_{AC} to the illumination system 100 and for generating a driving current 102 for supplying to the lighting unit 120. When the external power source stops supplying the power, the energy storage element 184 is configured for generating a discharging current that is supplied through the resistive element 182 to the lighting unit 120, thereby extending the time duration which a bright state of the lighting unit 120 goes to a dark state. addition, the number of the lighting unit 120 (e.g. LED) can be determined by the requirements of the practical application.

In this embodiment, the energy storage element 184 may include a capacitor. In other embodiment, this capacitor may be an electrolytic capacitor, a ceramic capacitor, a tantalum capacitor or any other type of the capacitors.

Further, in order to ensure that the driving current provided by the energy storage element 184 is utilized completely by the lighting unit 120 when the external power source stops providing the power, the time control circuit 180 may further include a current limiting element 186. The current limiting element 186 is electrically coupled between the drive circuit 160 and the time control circuit 180. The current limiting element 186 is configured for preventing the energy storage element 184 from discharging to the drive circuit 160. In other words, the current limiting element 186 intrinsically is a one-way conduction element, such as a diode or a silicon controlled rectifier, and a person of ordinary skill in the art can choose one of any other type in accordance with the requirements of the practical applications. For example, as shown in FIG. 1, the current limiting element 186 may be a diode, and the diode is electrically coupled between the drive circuit 160 and the energy storage element 184.

In brief, during normal operation of the aforementioned illumination system 100, the external power source provides power through the driving current 101 to the lighting unit 120 for emitting light, and at the same time, the energy storage element 184 is also charged by the driving current 101. When the external power source turns off, namely turns off the illumination system 100, the energy storage element 184 starts to release the previously stored power through the driving current 102. Due to the feature of the one-way conduction of the current limiting element 186, the driving current 102 is almost all released to the lighting unit 120. The resistive element 182 can be set in the path for the driving current 102 to flow through so that the driving current 120 is released slowly, When the external power source turns off, the lighting unit 120 receives the driving current 102 released from the energy storage element 102 to receive the corresponding power so that the lighting unit 120 continues to illuminate brightly until the power stored in the energy storage element 184 is released completely.

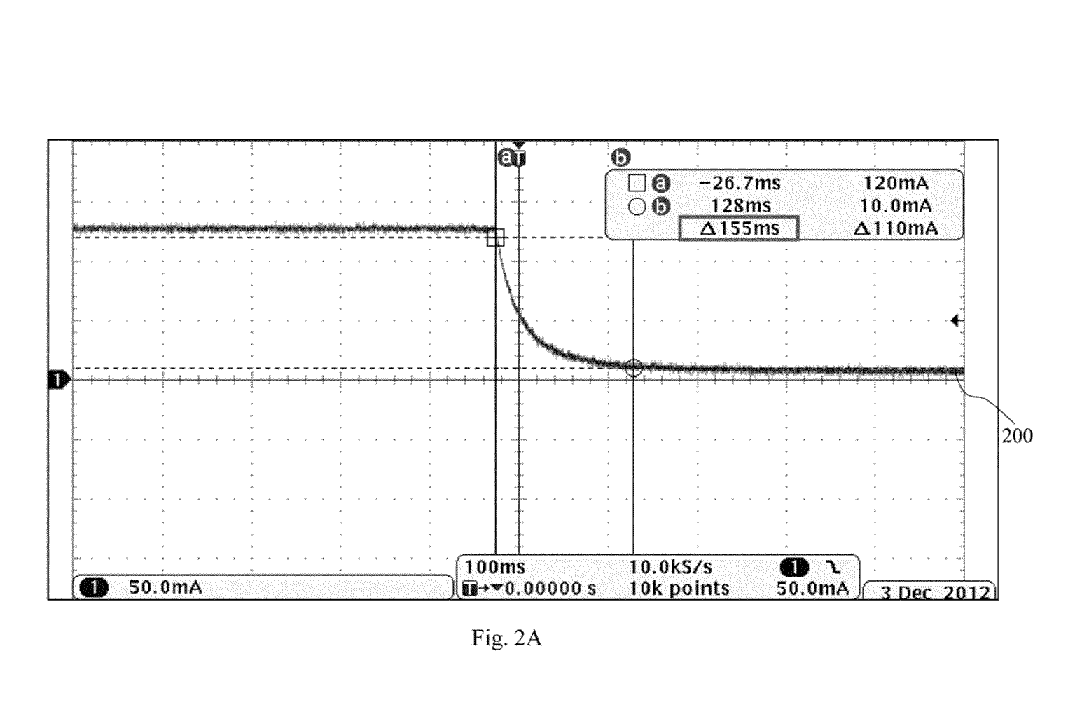

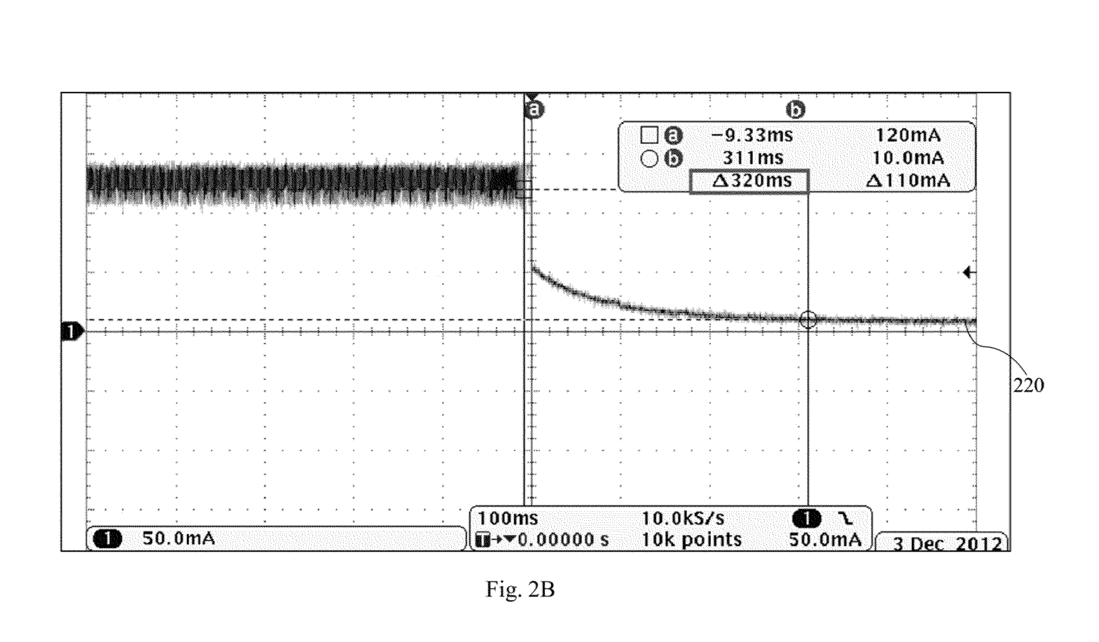

FIG. 2A and FIG. 2B are the waveforms of discharging current of the energy storage element 184 in FIG. 1. The waveforms shown in FIG, 2A and FIG. 2B are measured for the time during which the driving current generated from the energy storage element 184 is from 120 mA to 10 mA under the energy storage element 184 with constant 470 μF (namely the time duration which a bright state of the lighting unit 120 goes to a dark state). As shown in FIG. 1 and FIG. 2A, the current waveform 200 is measured without any resistive elements or current limiting elements, and the output terminal of the drive circuit 160 is only electrically coupled to a single energy storage element 184 in parallel, where the time Td of the current waveform 200 from 200 mA to 10 mA is 155 ms. Compared with FIG. 2A, the current waveform 220 shown in the FIG. 2B is measured with the aforementioned current limiting element 186 and the resistive element 182, wherein the resistance of the resistive element 182 is about 100 Ohm. The time Td of the current waveform 220 from 120 mA to 10 mA is 320 ms. Therefore, by utilizing the resistive element 182 to limit the current, the discharging current from the energy storage element 184 can be released slowly to extend the time duration which the energy storage element 184 supplies power to the lighting unit 120, thereby extending the time duration which the bright state of the lighting unit 120 goes to the dark state.

In this embodiment, if the resistance of the resistive element 184 is too low, the effect of extending the time duration which the bright state of the lighting unit 120 goes to the dark state will not be obvious. However, if the resistance of the resistive element 184 is too high, the driving current 101 generated from the drive circuit 160 will be wasted on the resistive element 184. Therefore, the illumination system shown in this disclosure can be adjusted in the practical application according to the output load, the size of a lamp, and the desired time from a bright state to a dark state in the illumination environment. For example, the time from the bright state to the dark state in a display window of the department store can be shorter and the time from the bright state to the dark state in a typical residential house can be longer For example, we can set the capacitance of the energy storage element 184 to 47 μF or to 470 μF according to the size of the lamp and the cost of the element. We can then adjust the amount of the time from the bright state to the dark state by setting different resistances of the resistive element 182 according to the different practical applications, as shown in Table 1, where the time from the bright state to the dark state is indicated as the buffer time. By referring the information in Table 1, we can adjust according to the different illumination environments.

TABLE 1
The buffer time for the different capacitances and resistances.

| | | | | | | |
|---|---|---|---|---|---|---|
| Current | N/A | A | A | A | A | A |
| limiting | | | | | | |
| element | | | | | | |
| Resistive | N/A | 50 | 100 | N/A | 50 | 100 |
| element | | | | | | |
| (Ω) | | | | | | |
| Energy | 47 | 47 | 47 | 470 | 470 | 470 |
| storage | | | | | | |
| element | | | | | | |
| (μF) | | | | | | |
| Buffer time | 16 | 28 | 36 | 155 | 240 | 320 |
| (ms) | | | | | | |

Further, in the different practical applications, the aforementioned energy storage element 184 can be an electrolytic capacitor, a ceramic capacitor, a tantalum capacitor or any other type of the capacitor. However, in general, an electrolytic capacitor may be used when the accuracy of the capacitance and the cost are desired, or, a tantalum capacitor may be used to minimize the size of the lamp.

According another embodiment in the present invention, as shown in FIG. 1, the illumination system 100 may further include an energy storage element 103. The energy storage element 103 can electrically coupled between the drive circuit 160 and the time control circuit 180. The energy storage element 103 is configured for filtering the high frequency noise on the driving current 101, and the energy storage element 103 is also charging when the external power source is supplying power. When the external power source stops supplying the power, the energy storage element 103 release the stored power to the lighting unit 120, namely providing another current path. Hence, the time duration which the bright state of the lighting unit 120 goes to the dark state can be more extended. In the practical applications, the energy storage element 103 may be a capacitor.

According to yet another embodiment of the present invention, the illumination system 100 may further include an additional resistive element 104. As shown in FIG. 1, the resistive element 104 is electrically coupled between the time control circuit 180 and the lighting unit 120. In general, the resistance of the resistive element 104 is high. When the discharging current provided from the energy storage element 184 and the energy storage element 103 is insufficient to drive the lighting unit 120, the resistive element 104 is configured for providing a discharging path to release the rest of the discharging current to avoid a situation in which the lamp is not completely turned off in the effective time.

In summary, the illumination system shown and described in this disclosure utilizes a resistive element to limit the speed of current releasing by the energy storage element and utilizes a capacitor to extend the time duration which a bright state of the lamp goes to a dark state. The illumination system can further utilize different combinations of the capacitances and resistances to adjust the time from the bright state to the dark state.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An illumination system, comprising:
at least one lighting unit;
a rectifier circuit for receiving an AC power provided from an external power source and rectifying the AC power to a DC power;
a drive circuit electrically coupled to the rectifier circuit to receive the DC power, wherein the drive circuit generates a first driving current; and
a time control circuit electrically coupled to the drive circuit, the time control circuit comprising:
a first resistive element; and
a first energy storage element electrically coupled to the first resistive element in series, wherein the first energy storage element is configured for charging while the external power source is supplying power to the illumination system and generating a second driving current to the at least one lighting unit, and wherein the first energy storage element is configured for generating a discharging current through the first resistive element to the at least one lighting unit when the external power source stops supplying power, thereby extending the time duration which a bright state of the at least one lighting unit goes to a dark state.

2. The illumination system of claim 1, wherein the time control circuit comprises:
a current limiting element electrically coupled between the drive circuit and the time control circuit, wherein the current limiting element is configured for preventing the first energy storage element from discharging to the drive circuit.

3. The illumination system of claim 2, wherein the current limiting element comprises a diode electrically coupled between the drive circuit and the first energy storage element.

4. The illumination system of claim 1, wherein the first energy storage element comprises a capacitor.

5. The illumination system of claim 4, wherein the capacitor is an electrolytic capacitor.

6. The illumination system of claim 1, further comprising a second energy storage element, electrically coupled between the drive circuit and the time control circuit in parallel.

7. The illumination system of claim 1, further comprising a second resistive element electrically coupled between the time control circuit and the lighting unit in parallel.

8. The illumination system of claim 7, wherein the second energy storage element comprises a capacitor.

9. The illumination system of claim 1, wherein the lighting unit comprises at least one light emitting diode.
